(19) United States
(12) Patent Application Publication
(10) Pub. No.: US 2003/0154642 A1
(43) Pub. Date: Aug. 21, 2003

(54) Animated looking fishing lure

(76) Inventor: Brandon Steele Johnston, Longview, TX (US)

Correspondence Address: BRANDON STEELE JOHNSTON, 1600 EVA DR., LONGVIEW, TX, 75605, US

(21) Appl. No.: 10/081,042

(22) Filed: Feb. 22, 2002

Related U.S. Application Data
(60) Provisional application No. 60/140,147, filed on Jun. 18, 1999.

(51) Int. Cl. A01K 85/00

(52) U.S. Cl. 43/42.33

(57) ABSTRACT

An animated looking fishing lure uses lenticular or a similar process of printed images as a core of a fishing lure to give a sense of movement or change in the image. The lenticular lens are combined with images of bait by attaching the lens to the image or the image to the lens or by attaching the two together simultaneously. The lens will be attached horizontally or vertically to allow the movement or change to be activated by the movement of the lure in the water up and down, side to side or back and forth. The lures can be different shapes and sizes with the printing encased within the lure.

This application is based on provisional application serial No. 60/140,147 filed Jun. 18, 1999.

### BACKGROUND OF THE INVENTION

This invention relates to fishing lures, and more particularly to an animated looking fishing lure.

It is known to have fishing lures of all shapes, sizes, and colors using plastics, rubber and other forms of lures all designed to fool the fish into thinking the lure is real food. These lures are known to use a variety of different types of printing on the lure. These printing types include line drawings, 4-color printing, watercolor, photographs and other forms of drawings and pictures to help in the deception of the fish.

### SUMMARY OF THE INVENTION

It is a primary object of this invention to provide fishing lures that include images that appear to move or change.

In accordance with a preferred embodiment of the present invention an animated looking fishing lure comprises a fishing lure having lenticular printed portions thereon.

In another preferred embodiment of the present invention, an animated looking fishing lure comprises lenticular printing and lenses adhered thereto. A preferred embodiment also includes a casing surrounding the fishing lure.

Other objects and advantages of the cutting-device will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side perspective view of a fishing lure in accordance with a preferred embodiment of the present invention.

FIG. 2 is a cross-sectional view of a fishing lure in accordance with an alternate embodiment of the present invention.

FIG. 3 is a cross-sectional view of a fishing lure in accordance with an alternate embodiment of the present invention.

FIG. 4 is a cross-sectional view of a fishing lure in accordance with an alternate embodiment of the present invention.

FIG. 5 is a cross-sectional view of a fishing lure in accordance with an alternate embodiment of the present invention.

FIG. 6 is a cross-sectional view of a fishing lure in accordance with an alternate embodiment of the present invention.

FIG. 7 is a cross-sectional view of a fishing lure in accordance with an alternate embodiment of the present invention.

FIG. 8 is a side perspective view of a fishing lure in accordance with an alternate embodiment of the present invention.

### DETAILED DESCRIPTION OF THE PREFERRED EMBODIMENTS

Detailed description of the preferred embodiments is provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

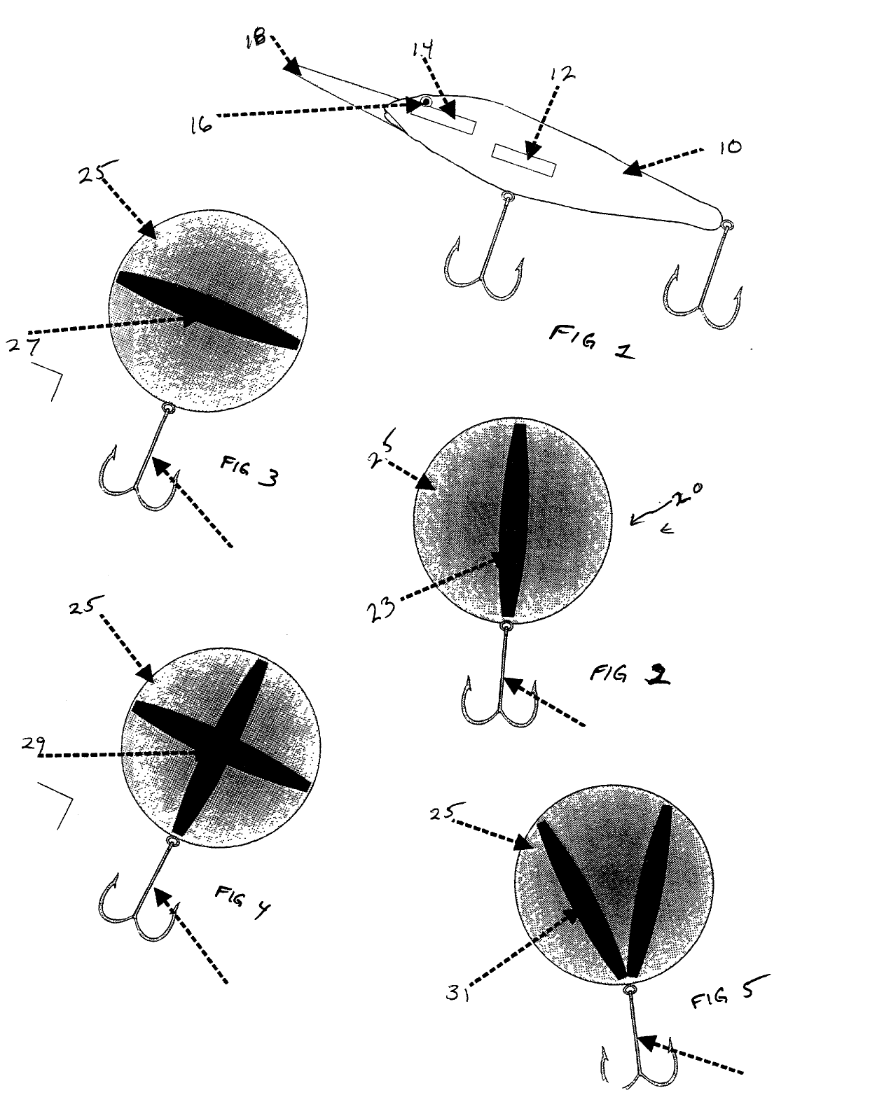

Turning first to FIG. 1 there is shown a fishing lure 10 in accordance with a preferred embodiment of the present invention. Fishing lure 10 is shown in the shape of a fish, but may be of any of a variety of shapes and images thereon as are well know to the fishing lure industry. In addition, fishing lure 10 may be made of a variety of materials, also well known in the fishing industry. Fishing lure 10 in the illustrated embodiment is provided with one ore more motion sensors 12 for sensing motion and one or more sound devices 14 for creating sound, both of which may aid in attracting a fish to the fishing lure 10. For example, motion sensor 12 may detect when fishing lure 10 is moving through the water and interact to have Sound device 14 create a sound to attach a fish. In addition, fishing lure 10 includes a fishing line attachment 18 to attach fishing lure 10 to a fishing line and may be of a variety of designs well known in the fishing lure industry.

As is shown in FIG. 1, Fishing lure 10 is also provided with at lease one, and can have more than one, lenticular printed sections 16. In the illustrated embodiment, fishing lure 10 has lenticular printed section 16 at the eye portion of fishing lure 10, but may be in more than one place and can be anywhere on fishing lure 10. In addition, it will be appreciated that lenticular printed section 16 may be printed and integral with fishing lure 10 or may be separately printed and adhered to fishing lure 10 in a variety of fashions including adhesive or other well known bonding methods.

In the illustrated embodiment of FIG. 1, with lenticular printed section 16 at fishing lure 10 eye portion, it can be appreciated through the appropriate printing that fishing lure 10 eye portion can have the appearance of movement, blinking, changing color, or a combination thereof.

Turning now to FIG. 2 at which is illustrated an alternate embodiment of the present invention, fishing lure 20 is shown having a centrally located body portion 23, the entirety of which is a lenticular printed material. Body portion 23 may be of a variety of shapes, sizes and materials, including, for example, a fish 2 inches long, 1 inch high, ¼ inch thick, of standard lenticular printed material. Body portion 23 is placed vertically within a generally cylindrically shaped clear plastic encasement 25. Encasement 25 may be of any sufficient shape to cover body portion 23 and made of any suitable material such as rubberized plastic, hard plastic, rubber, etc.

FIG. 3 is similar to FIG. 2 with body portion 27 placed horizontally in encasement 25.

FIG. 4 is similar to FIGS. 2 and 3, but has body portion 29 in encasement 25 in a T-shaped configuration with lenticular printed portion 16 on all sides of fishing lure 10.

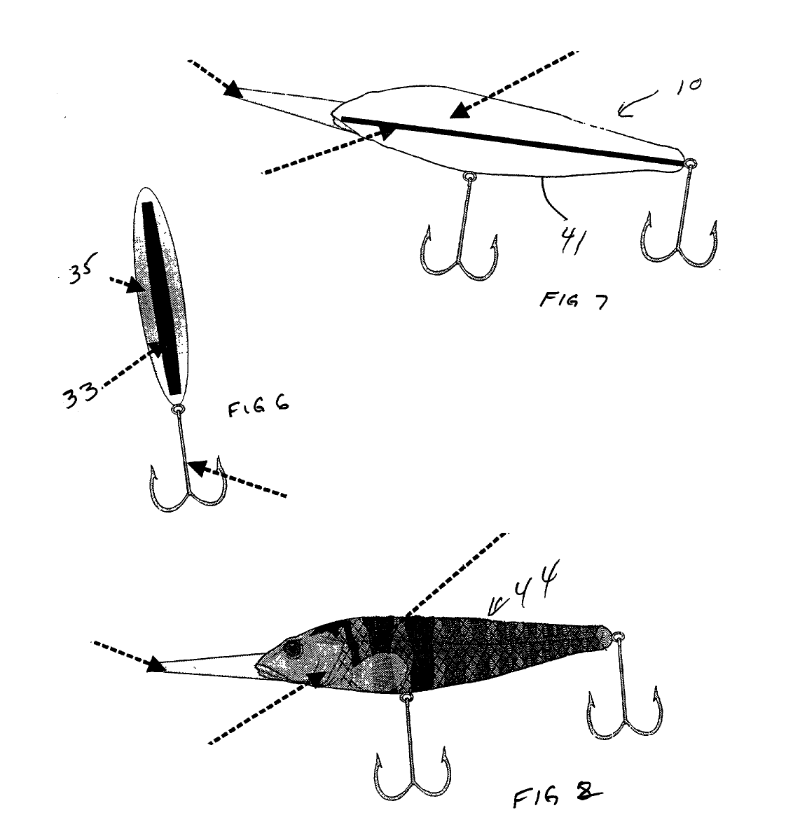

FIG. 5 is similar to FIGS. 2, 3, and 4 but has body portion 31 in encasement 25 in a V-shaped configuration with lenticular printed portion 16 on all sides of fishing lure 10.

FIG. 6 is similar to FIGS. 2 through 5, but has body portion 33 in encasement 35, where encasement 35 is illustrated as generally flat shaped and more closely conforming to the shape of body portion 33.

FIG. 7 is a cross-sectional view of the fishing lure 10 of FIG. 3 from a perpendicular view with body portion 27 in a fish-like shape encasement. FIG. 7 also

FIG. 8 illustrates an alternate preferred embodiment of the present invention with body portion 44 not encased, but able to contact water and fish.

The lenticular lens is combined to the image by attaching the lens to the image, the image to the lens or simultaneously attaching the two together, in a conventional manner know in the lenticular printing art, while the images are glued back to back to form images on each side of the lure. The lenticular images and lenses may have a textured top that can be affixed to the image horizontally or vertically, and may be made of a textured plastic material.

It will be appreciated that other forms of fishing lures may be made in accordance with the invention herein such as spinners, hooks, spoons, or other such devices.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An animated looking fishing lure comprising;
a fishing lure: and
at least one lenticular printed portion adhered to the fishing lure.

2. The images of claim 1 wherein being created by adhering a lens to an image or an image to a lens or by combining the two together simultaneously.

3. The images of claim 1 wherein the images will be single or double sided and placed on or within the lure.

4. The images of claim 1 wherein multiple images may be used in multiple angles and configurations on or within the lure.

5. The images of claim 1 wherein the lens will be affixed to the image horizontally or vertically to allow the action of the image to be activated by turning the image from top to bottom or left to right.

6. The ‘LOOKS’ hooks in claim 1 wherein the casing of said ‘LOOKS’ hooks will include all currently used forms of casing techniques and materials as well as any future forms of techniques and materials used for making lures.

7. The casing in claim 5 wherein will be made of a durable clear plastic or rubber and will protect the image from damage or destruction.

8. The movement in claim 1 wherein interest of the fish will be peaked by the attraction of the movement created by the images.

9. The ‘LOOKS’ hooks in claim 1 wherein the ‘LOOKS’ hooks are constituted by the use of lenticular images within or on the lure.

10. The casing in claim 5 wherein the casing of said ‘LOOKS’ hooks will include all shapes, colors and sizes like that of bait according to what shapes and sizes will attract fish.

11. The ‘LOOKS’ hooks in claim 1 wherein sounds may be incorporated by means that are currently in use today or any sound technology that may be used in the future.

12. The ‘LOOKS’ hooks in claim 1 wherein current adaptations or future adaptations of fishing lures such as spinners, hooks, spoons, or other such devices will also be incorporated into the ‘LOOKS’ hooks.
